(19) United States
(12) Patent Application Publication
(10) Pub. No.: US 2026/0311377 A1
(43) Pub. Date: Oct. 8, 2026

(54) Video Compression Method and Device with Multi-Scale Implicit Neural Representation

(71) Applicant: University of Chinese Academy of Sciences, Beijing (CN)

(72) Inventors: Xinfeng ZHANG, Beijing (CN); Jun ZHU, Beijing (CN)

(73) Assignee: University of Chinese Academy of Sciences, Beijing (CN)

(21) Appl. No.: 19/212,770

(22) Filed: May 20, 2025

(30) Foreign Application Priority Data
Apr. 7, 2025 (CN) 202510429495.8

(51) Int. Cl. G06T 9/00; G06N 3/0455; G06N 3/08; G06T 3/4007; G06T 3/4046

(52) U.S. Cl. CPC G06T 9/002; G06N 3/0455; G06N 3/08; G06T 3/4007; G06T 3/4046

(57) ABSTRACT

A video processing method with multi-scale implicit neural representation includes: using an implicit neural network to convert an original video sequence into network parameters; using the implicit neural network to extract fused encoding features with temporal information and perform spatial decoding, where the fused encoding features are selected based on the original video sequence; constructing a loss function of the implicit neural network based on the original video sequence and a reconstructed video, where the reconstructed video is obtained by reconstructing the original video sequence; using the loss function to iteratively optimize the network parameters, where the final optimized network parameters are used as the video compression results corresponding to the original video sequence. Therefore, by adopting the video processing method, the spatial and temporal structural priors of the video can be fully leveraged, enabling the compression efficiency to reach optimal levels and improving video compression performance.

### CROSS REFERENCE TO THE RELATED APPLICATIONS

This application is based upon and claims priority to Chinese Patent Application No. 202510429495.8, filed on Apr. 7, 2025, the entire contents of which are incorporated herein by reference.

### TECHNOLOGY

The application belongs to the technical field of video compression, in particular to multi-scale implicit neural representation-based video compression method and device.

### BACKGROUND

With the rapid development of digital media technology, video content has become increasingly prevalent in multimedia communication, video streaming services, video surveillance, and various smart devices. Traditional video compression technologies are primarily based on hybrid coding frameworks, such as H.264/AVC, H.265/HEVC, and H.266/VVC. With the advancement of deep learning, video compression methods based on deep learning have gradually emerged.

In deep learning-based methods, the powerful feature extraction capabilities of neural networks are leveraged to model and encode video data, further improving compression efficiency. However, current deep learning-based video compression methods mainly rely on data-driven feature learning and fail to fully utilize the spatial and temporal structural priors of video content. As a result, compression efficiency cannot reach its optimal level, leading to reduced video compression performance.

### SUMMARY

The application provides a video compression method and device with multi-scale implicit neural representation. To provide a basic understanding of certain aspects of the embodiment, a brief summary is presented below. This summary is not intended as an exhaustive overview, nor is it meant to identify key or essential components, or to define the scope of protection of the embodiment. Its sole purpose is to present some concepts in a simplified form as a prelude to the more detailed description that follows.

The embodiment of the first aspect of the application proposes a video compression method with multi-scale implicit neural representation, including:
Modeling the original video sequence by implicit neural network and convert the original video sequence to the network parameters. The implicit neural network is used to extract fused encoding features with temporal information and perform spatial decoding, where the fused encoding features are selected based on the original video sequence;
Constructing the loss function of the implicit neural network based on the original video sequence and reconstructed video, the reconstructed video is obtained by reconstructing the original video sequence;
Iteratively optimizing the network parameters using the loss function until the optimization results meet preset conditions, and use the final optimized network model parameters as the video compression result corresponding to the original video sequence.
Optionally, the implicit neural network includes an encoder and a decoder;

Constructing the loss function of the implicit neural network based on the original video sequence and reconstructed video, it includes:
Dividing each frame in the original video sequence into multiple image blocks;
Using the encoder to add preset basic encoding features processed by sliding temporal windows with preset group-of-pictures level features to obtain fused encoding features which contain temporal information;
Extracting the feature embedding representation corresponding to each image block from the fused encoding features, based on the coordinates of each image block;
Performing spatial decoding and reconstruction of the feature embedding representation corresponding to each image block to obtain the reconstructed video corresponding to the original video sequence.

Constructing the loss function based on the original video sequence and the reconstructed video.

Optionally, adding preset basic encoding features processed by sliding temporal windows with preset group-of-pictures level features to obtain fused encoding features which contain temporal information, including:
Processing the original video sequence using the sliding temporal window to generate feature tensors for each frame;
Performing weighted fusion of the feature tensors of frames within the sliding temporal window to obtain fusion results of multiple local windows;
Integrating the fusion results of multiple local windows into temporally aligned fused features with respect to the time axis of the original video sequence;
Using preset basic encoding features, incorporating preset group-of-pictures level features into the temporally fused features to obtain fused encoding features containing temporal information.

Optionally, incorporating preset group-of-pictures level features into the temporally fused features, including:
Grouping the original video sequence into multiple sets of frames;
Assigning a preset learnable feature tensor for each set of frames;
Element-wisely adding the learnable feature tensor to the temporally fused features.

Optionally, extracting the feature embedding representation corresponding to each image block from the fused encoding features, based on the coordinates of each image block, including:
Calculating mapping coordinates in the fused encoding features containing temporal information based on the image block coordinates of each image block;
Obtaining the feature embedding representation corresponding to each image block from the fused encoding features according to the mapping coordinates;
Determining the image block coordinates of each image block based on the spatial coordinate index and the network encoding parameters of each image block in the original video sequence.

Optionally, the decoder includes a plurality of serially connected upsampling modules, each upsampling module including a hybrid upsampling layer and multiple feature fusion layers, and each upsampling module is provided with a cross-layer fusion mechanism;
Performing spatial decoding and reconstruction of the feature embedding representation corresponding to each image block to obtain the reconstructed video corresponding to the original video sequence includes:
Performing hybrid umsampling on the feature embedding representations corresponding to each image block using the hybrid upsampling layer, which applies different types of upsampling functions to obtain upsampled features;
Fusing the upsampled features through the feature fusion layers to generate hybrid upsampled features;
Determining the features of the current layer;
Using the cross-layer fusion mechanism to concatenate the hybrid upsampled features output by multiple feature fusion layers, then applying grouped convolution for dimensional mapping, and combining the result with the current layer's features to obtain the final features from the last upsampling module;
Extracting features at each resolution through each upsampling module to obtain multi-resolution features;
Reconstructing the video using the features obtained from the last upsampling module to generate the reconstructed video corresponding to the original video sequence.

Optionally, performing hybrid umsampling on the feature embedding representations using different types of upsampling functions, and fusing the upsampled features through the feature fusion layers to generate hybrid upsampled features include:
Performing bilinear interpolation on the feature embedding representations corresponding to each image block for upsampling, while simultaneously applying sub-pixel convolution upsampling on the same feature embedding representations through pixel shuffle;
Adding the two types of upsampled features to obtain the hybrid upsampled features.

Optionally, determining the features of the current layer includes:
Extracting features from the hybrid upsampled features using convolution layers with different kernel sizes to obtain convolution fused features;
Adjusting the feature dimensions of the multi-resolution features through a linear transformation layer to obtain dimensional transformed features;
Slicing the convolution fused features along the channel dimension and adding them to the dimensional transformed features to obtain the features of the current layer.

Optionally, constructing the loss function based on the original video sequence and the reconstructed video includes:
Downsampling the original video sequence to obtain downsampled features;
Calculating a multi-scale loss based on the downsampled features and the multi-resolution features;
Computing the residual between the original video sequence and the reconstructed video, and extracting high-frequency residual information using a high-pass filter;
Constructing a high-frequency loss term based on the high-frequency residual information;
Establishing an expression combining the multi-scale loss and the high-frequency loss to serve as the loss function.

The embodiment of the second aspect of the application provides a video compression device, including:
A modeling module, configured to model the original video sequence using an implicit representation neural network model, so as to convert the original video sequence into the network model parameters of the implicit representation neural network model; wherein the implicit representation neural network model is used to extract fused encoding features containing temporal information and to perform spatial decoding and reconstruction, and the fused encoding features are selected based on the original video sequence;
A construction module, configured to construct a loss function of the implicit representation neural network model based on the original video sequence and the reconstructed video, wherein the reconstructed video is obtained by reconstructing the original video sequence;

An optimization module, configured to iteratively optimize the network model parameters using the loss function, and when the optimization result satisfies a preset condition, output the final optimized network model parameters as the video compression result corresponding to the original video sequence.

The technical solution provided in the embodiment of the application has at least the following technical effects or advantages:
In the embodiment of the present application, on one hand, the implicit neural network is employed to extract fused encoding features containing temporal information and to perform spatial decoding and reconstruction. These fused encoding features are selected based on the original video sequence, thereby enabling full utilization of the spatial and temporal structural priors of the video to effectively remove redundant information and improve the compression efficiency. On the other hand, the implicit representation neural network model is capable of multi-scale feature fusion, which enhances the network's representation capability for video features, thereby optimizing the compression performance.

It should be understood that the above general description and the following detailed description are merely exemplary and explanatory, and are not intended to limit the present application in any way.

### BRIEF DESCRIPTION OF THE DRAWINGS

The attached drawings, which are incorporated in and constitute a part of the present specification, illustrate the embodiment of the present application and, together with the description, serve to explain the principles of the present application.

FIG. 1 is a schematic flowchart illustrating a method for video compression based on a multi-scale implicit neural representation according to an embodiment of the present application;

FIG. 2 is a schematic diagram illustrating the processing procedure of an encoder module according to an embodiment of the present application;

FIG. 3 is a structural diagram illustrating a decoder module according to an embodiment of the present application;

FIG. 4 is a schematic structural diagram of a video compression device based on multi-scale implicit neural representation according to an embodiment of the present application;

FIG. 5 is a schematic structural diagram of an electronic device according to an embodiment of the present application.

### DETAILED DESCRIPTION OF THE EMBODIMENTS

The following description and attached drawings sufficiently illustrate specific embodiments of the present application, enabling those skilled in the art to practice them.

It should be clearly understood that the described embodiments represent only a portion of the embodiments of the present application and not all of them. All other embodiments obtained by those of ordinary skill in the art based on the embodiments in this application, without creative effort, shall fall within the scope of protection of the present application.

In the following description referring to the drawings, unless otherwise indicated, the same reference numerals in different figures represent the same or similar elements. The implementations described in the following exemplary embodiments do not represent all implementations consistent with the present application. Instead, they are merely examples of devices and methods consistent with certain aspects of the present application as detailed in the appended claims.

In the description of the present application, it should be understood that the terms “first”, “second”, and the like are used solely for descriptive purposes and should not be interpreted as indicating or implying relative importance. Those skilled in the art can interpret the specific meanings of the above terms in this application depending on the context. Furthermore, unless otherwise specified, the term “a plurality of” refers to two or more. The term “and/or” describes an associative relationship between related objects, indicating the presence of any one of the three possible relationships —for example, “A and/or B” may mean: A alone, A and B together, or B alone. The character “/” generally indicates an “or” relationship between the associated objects.

The present application provides a video compression method and apparatus with multi-scale implicit neural representation to address the issues identified in the related techniques. In the embodiment of the present application, on one hand, the implicit neural network is employed to extract fused encoding features containing temporal information and to perform spatial decoding and reconstruction. These fused encoding features are selected based on the original video sequence, thereby enabling full utilization of the spatial and temporal structural priors of the video to effectively remove redundant information and improve the compression efficiency. On the other hand, the implicit representation neural network model is capable of multi-scale feature fusion, which enhances the network's representation capability for video features, thereby optimizing the compression performance, the following provides a detailed description with exemplary embodiments.

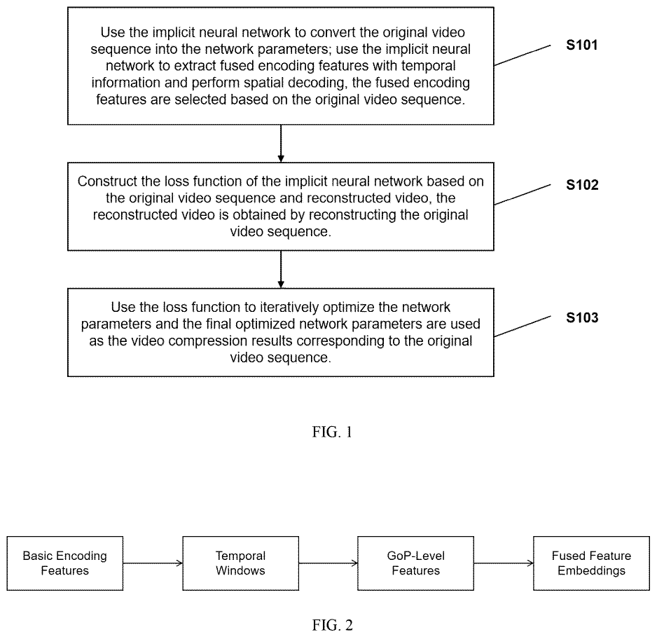

The following provides a detailed description of the video compression method offered in the embodiments of the present application, with reference to FIGS. 1 to 3. This method can be implemented through a computer program and operated on a video compression device based on the Von Neumann architecture. The computer program can be integrated within an application or run as an independent utility tool.

Refer to FIG. 1, which illustrates a flowchart of the video compression method with multi-scale neural representation according to an embodiment of the present application. As shown in FIG. 1, the method includes the following steps:

S101, an implicit representation neural network is used to model the original video sequence, thereby converting the original video sequence into network parameters of the model. The implicit representation neural network is employed to extract fused encoding features that contain temporal information and to perform spatial decoding and reconstruction. The fused encoding features are selected based on the original video sequence.

Specifically, the implicit representation neural network is a neural network-based model designed to encode input data (e.g., a video sequence) into a compact implicit representation (latent space representation) through an encoder, and to reconstruct the original data from this representation through a decoder. The network parameters refer to the learned compact representation of the video, which can be used for reconstructing the original video sequence. The fused encoding features are extracted by the encoder of the network and contain both temporal and spatial information. Temporal information captures the correlations across video frames and is used to model dynamic changes in the video. Spatial information captures the intra-frame correlations and is used to model the internal structure of video frames.

In the embodiment of the present application, a segment of high-definition video sequence is selected as the input data. For example, a 10-second video with a resolution of 1920×1080 and a frame rate of 30 fps is chosen. The video sequence is loaded into the system and stored as a series of consecutive video frames. An implicit neural representation (INR) model is designed, which consists of two parts: an encoder and a decoder. The encoder is responsible for feature extraction or feature selection. It includes a set of learnable feature tensors that represent the corresponding video sequence. The decoder reconstructs the video by generating output tensors of the same size as the original video sequence. The model jointly optimizes both the encoder and decoder to enhance the quality of the reconstructed video. Through this process, the original video sequence is converted into the network model parameters of the implicit neural representation model, thereby achieving efficient encoding of video content.

S102, construct the loss function of the implicit neural network based on the original video sequence and the reconstructed video.

The implicit neural network includes an encoder and a decoder.

In some embodiments of the present application, the specific process of constructing the loss function includes the following steps: dividing each frame in the original video sequence into multiple image blocks; using the encoder to add preset basic encoding features processed by sliding temporal windows with preset group-of-pictures level features to obtain fused encoding features which contain temporal information; extracting the feature embedding representation corresponding to each image block from the fused encoding features, based on the coordinates of each image block; performing spatial decoding and reconstruction of the feature embedding representation corresponding to each image block to obtain the reconstructed video corresponding to the original video sequence. constructing the loss function based on the original video sequence and the reconstructed video.

The predefined block size refers to a preset size, measured in pixels, used to divide each video frame into a plurality of smaller image blocks. The original video sequence refers to uncompressed or unprocessed video data including a continuous sequence of video frames.

In some embodiments of the present application, the predefined block size is determined based on actual requirements. For example, a block size of 120×120 may be selected. For a video frame with a resolution of 1920×1080, the frame can be divided into 18×9 image blocks (since 1920÷120=18 and 1080÷120=9).

The image block coordinates refer to the position of the image blocks within a video frame, represented in pixel coordinates. The feature embedding representation refers to the feature representation of a specific image block, extracted by the encoder from the fused encoding features, and serves as the input to the decoder for reconstructing the content of the corresponding image block. The loss function is a function used to measure the difference between the original data and the reconstructed data, and is utilized for optimizing the parameters of the neural network.

Specifically, the process of obtaining the fused encoding features containing temporal information by add preset basic encoding features processed by sliding temporal windows with preset group-of-pictures level features includes: processing the original video sequence using the sliding temporal window to generate feature tensors for each frame; performing weighted fusion of the feature tensors of frames within the sliding temporal window to obtain fusion results of multiple local windows; integrating the fusion results of multiple local windows into temporally aligned fused features with respect to the time axis of the original video sequence; using preset basic encoding features, incorporating preset group-of-pictures level features into the temporally fused features to obtain fused encoding features containing temporal information.

Specifically, the process of using preset basic encoding features and incorporating preset group-of-pictures level features into the temporally fused features includes: grouping the original video sequence into multiple sets of frames; assigning a preset learnable feature tensor for each set of frames; element-wisely adding the learnable feature tensor to the temporally fused features.

Specifically, the process of extracting the feature embedding representation corresponding to each image block from the fused encoding features based on the coordinates of each image block includes: calculating mapping coordinates in the fused encoding features containing temporal information based on the image block coordinates of each image block; obtaining the feature embedding representation corresponding to each image block from the fused encoding features according to the mapping coordinates; determining the image block coordinates of each image block based on the spatial coordinate index and the network encoding parameters of each image block in the original video sequence.

In one possible implementation, the Adam optimization algorithm is employed to train the neural network, where the initial learning rate is set to 2e-3. A warm-up mechanism is adopted, with an initial warm-up learning rate of 2e-5 and a minimum learning rate maintained at 2e-5 to ensure training stability in the early stages. The total number of training epochs is set to 300, with evaluation performed every 30 epochs. During each training epoch, a set of neural network parameters is obtained, each corresponding to a different rate-distortion tradeoff. By continuously optimizing the rate-distortion performance, the model achieves an optimal balance between compression efficiency and reconstruction quality. This embodiment supports quantization aware training to further compress the neural network parameters. The quantization levels include 8-bit, 7-bit, and 6-bit precision. Quantization noise with a magnitude of 0.9 is introduced to enhance the robustness of the model. Finally, the encoded network parameters are transmitted to the decoder side, where the decoding network has a structure identical to that of the encoding network, but utilizes the quantized parameters during decoding to reconstruct the video sequence.

As illustrated in FIG. 2, a temporal window mechanism and group-of-pictures (GOP)-level features are designed to generate the feature embedding corresponding to each image block. This enhances the network's temporal representation capability and ensures consistency in modeling the video's temporal structure.

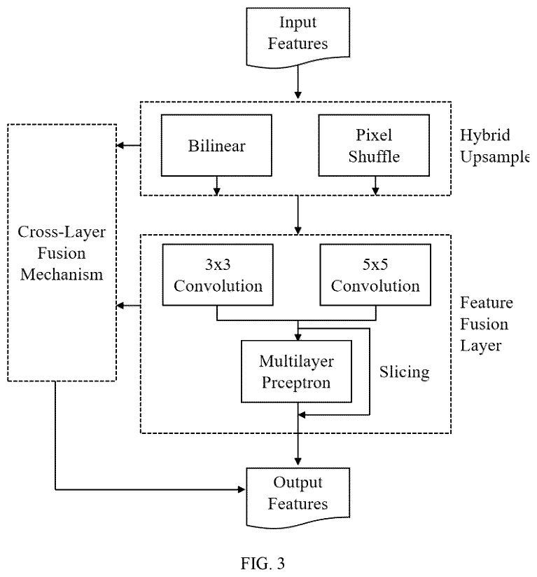

As shown in FIG. 3, the decoder includes a plurality of serially connected upsampling modules. Each upsampling module includes a hybrid upsampling layer and multiple feature fusion layers. Additionally, each upsampling module is provided with a cross-layer fusion mechanism.

In some embodiments, performing spatial decoding and reconstruction of the feature embedding representation corresponding to each image block to obtain the reconstructed video corresponding to the original video sequence includes: performing hybrid umsampling on the feature embedding representations corresponding to each image block using the hybrid upsampling layer, which applies different types of upsampling functions to obtain upsampled features; fusing the upsampled features through the feature fusion layers to generate hybrid upsampled features; determining the features of the current layer; using the cross-layer fusion mechanism to concatenate the hybrid upsampled features output by multiple feature fusion layers, then applying grouped convolution for dimensional mapping, and combining the result with the current layer's features to obtain the final features from the last upsampling module; extracting features at each resolution through each upsampling module to obtain multi-resolution features; reconstructing the video using the features obtained from the last upsampling module to generate the reconstructed video corresponding to the original video sequence.

Specifically, performing hybrid umsampling on the feature embedding representations corresponding to each image block using different types of upsampling functions, and fusing the upsampled features through the feature fusion layers to generate hybrid upsampled features include: performing bilinear interpolation on the feature embedding representations corresponding to each image block for upsampling, while simultaneously applying sub-pixel convolution upsampling on the same feature embedding representations through pixel shuffle; adding the two types of upsampled features to obtain the hybrid upsampled features.

Specifically, determining the features of the current layer includes: extracting features from the hybrid upsampled features using convolution layers with different kernel sizes to obtain convolution fused features; adjusting the feature dimensions of the multi-resolution features through a linear transformation layer to obtain dimensional transformed features; slicing the convolution fused features along the channel dimension and adding them to the dimensional transformed features to obtain the features of the current layer.

Specifically, constructing the loss function based on the original video sequence and the reconstructed video includes: downsampling the original video sequence to obtain downsampled features; calculate a multi-scale loss based on the downsampled features and the multi-resolution features; computing the residual between the original video sequence and the reconstructed video, and extracting high-frequency residual information using a high-pass filter; constructing a high-frequency loss term based on the high-frequency residual information; establishing an expression combining the multi-scale loss and the high-frequency loss to serve as the loss function.

As illustrated in FIG. 3, the hybrid upsampling layer includes two parallel branches: one performing bilinear interpolation and the other performing sub-pixel convolution via pixel shuffle. The features obtained from both branches are fused to generate hybrid upsampled features.

The feature fusion layer includes convolution layers with different kernel sizes to extract multi-scale features. These features are then fused and passed through a linear connection layer for dimensional transformation. Subsequently, the fused convolution features are cropped along the channel dimension and added to the dimension-transformed features to enhance the representational capacity.

The cross-layer fusion mechanism is configured to concatenate features from different layers along the channel dimension. The concatenated features are subjected to grouped convolution for dimensional mapping, and the output is added to the features generated from the feature fusion layer, thereby facilitating effective cross-layer information integration.

S103, the loss function is utilized to iteratively optimize the network parameters until a predefined condition is satisfied. The finally optimized network parameters are designated as the video compression result corresponding to the original video sequence.

The loss function serves as a quantitative metric that measures the discrepancy between the model output (i.e., the reconstructed video) and the target (i.e., the original video). By minimizing the loss function, the parameters of the network can be effectively optimized, thereby enhancing the model's performance. The predefined optimization termination conditions may include, for example, the loss function value falling below a specified threshold, or the number of iterations reaching a preset maximum. The video compression result refers to the optimized network parameters, which can be subsequently used to reconstruct the original video sequence.

In some embodiments of the present application, an optimization algorithm (e.g., Adam optimizer) is employed to iteratively optimize the network model parameters. During each iteration, the value of the loss function is calculated, and the network model parameters are updated based on the computed gradients. A check is then performed to determine whether predefined conditions are met, such as whether the loss function value falls below a specified threshold or whether the maximum number of iterations has been reached. When the optimization results meet the preset conditions, the final optimized network parameters are stored as the video compression result.

In the embodiment of the present application, on the one hand, the implicit neural representation (INR) model is utilized to extract fusion encoding features that contain temporal information and to perform spatial decoding and reconstruction. The fusion encoding features are selected based on the original video sequence, thereby enabling the full exploitation of prior knowledge regarding the spatial and temporal structure of the video. This effectively removes redundant information and improves the compression rate. On the other hand, the INR model is capable of multi-scale feature fusion, which enhances the model's expressive ability for video features and thus optimizes the compression performance.

The following describes the apparatus embodiment of the present application, which may be used to implement the method embodiment described herein. For details not disclosed in the apparatus embodiment, reference may be made to the corresponding method embodiment of the present application.

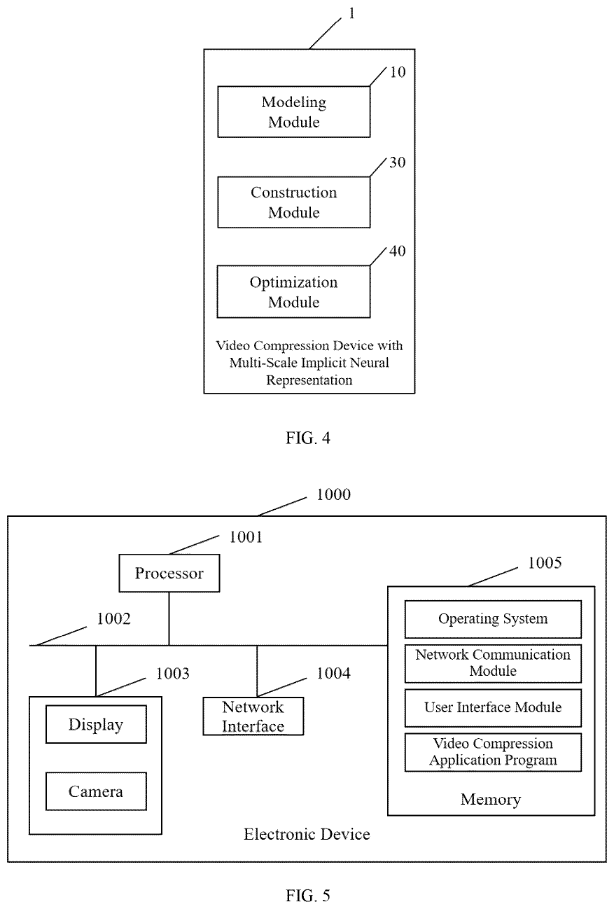

Please refer to FIG. 4, which illustrates a schematic structural diagram of a video compression apparatus according to an exemplary embodiment of the present application. The video compression apparatus may be implemented in software, hardware, or a combination of both, and may constitute all or part of an electronic device. The apparatus 1 includes the following modules: modeling module 10, partitioning module 20, construction module 30, and optimization module 40.

The Modeling Module 10 is configured to perform modeling on an original video sequence using an implicit neural representation (INR) model, so as to convert the original video sequence into network parameters of the INR model. The INR model is further configured to extract fusion encoding features containing temporal information and to perform spatial decoding and reconstruction. The fusion encoding features are selected based on the original video sequence.

The Construction Module 20 is configured to construct a loss function of the INR model based on the original video sequence and a reconstructed video, wherein the reconstructed video is obtained by reconstructing the original video sequence.

The Optimization Module 30 is configured to perform iterative optimization of the network parameters using the loss function, and to determine, upon the optimized result meeting a predetermined condition, the final optimized network parameters as the video compression result corresponding to the original video sequence.

It should be noted that the above-described video compression apparatus is described by dividing the functionality into the aforementioned functional modules merely for illustrative purposes. In practical applications, the functions may be distributed and performed by different modules as needed. That is, the internal structure of the device may be divided into different functional modules to implement all or part of the functionalities described above. Furthermore, the video compression apparatus provided in the above-described embodiment shares the same inventive concept as the method embodiment, and the detailed implementation process is described in the corresponding method embodiment, which will not be repeated here.

The serial numbers of the embodiment provided herein are solely for descriptive purposes and do not indicate any preference or priority of the embodiment.

In the embodiment of the present application, on one hand, the implicit neural network is employed to extract fused encoding features containing temporal information and to perform spatial decoding and reconstruction. These fused encoding features are selected based on the original video sequence, thereby enabling full utilization of the spatial and temporal structural priors of the video to effectively remove redundant information and improve the compression efficiency. On the other hand, the implicit representation neural network model is capable of multi-scale feature fusion, which enhances the network's representation capability for video features, thereby optimizing the compression performance.

The present application further provides a computer-readable medium having stored thereon program instructions which, when executed by a processor, implement the video compression method provided in the foregoing method embodiment.

The present application also provides a computer program product including instructions which, when executed on a computer, cause the computer to perform the video compression method as described in the foregoing method embodiment.

Refer to FIG. 5, which illustrates a schematic structural diagram of an electronic device according to an embodiment of the present application. As shown in FIG. 5, the electronic device 1000 may include: at least one processor 1001, at least one network interface 1004, a user interface 1003, a memory 1005, and at least one communication bus 1002.

The communication bus 1002 is configured to enable communication and interconnection between these components.

The user interface 1003 may include a display and a camera. Optionally, the user interface 1003 may further include standard wired interfaces and wireless interfaces.

The network interface 1004 may optionally include standard wired interfaces and wireless interfaces (such as Wi-Fi interfaces).

The processor 1001 may include one or more processing cores. The processor 1001 connects various components within the electronic device 1000 via various interfaces and buses. By executing instructions, programs, code sets, or instruction sets stored in the memory 1005 and accessing data stored therein, the processor 1001 performs various functions of the electronic device 1000 and processes data. Optionally, the processor 1001 may be implemented using at least one hardware form selected from: Digital Signal Processing (DSP), Field-Programmable Gate Array (FPGA), or Programmable Logic Array (PLA). The processor 1001 may integrate one or more of the following components: Central Processing Unit (CPU), Graphics Processing Unit (GPU), and modem. The CPU primarily processes the operating system, user interface, and application programs; the GPU is responsible for rendering and drawing content displayed on the screen; and the modem handles wireless communications. It is understood that the modem may also be implemented as a standalone chip separate from the processor 1001.

The memory 1005 may include Random Access Memory (RAM) and/or Read-Only Memory (ROM). Optionally, the memory 1005 includes a non-transitory computer-readable storage medium. The memory 1005 may be used to store instructions, programs, code, code sets, or instruction sets. The memory 1005 may include a program storage region and a data storage region. The program storage region may store instructions for implementing an operating system, instructions for implementing at least one function (such as touch control functionality, audio playback functionality, image playback functionality, etc.), and instructions for executing the methods provided in the foregoing embodiment. The data storage region may be used to store data involved in the aforementioned method embodiment. Optionally, the memory 1005 may also include at least one storage system that is located remotely from the processor 1001. As shown in FIG. 5, the memory 1005, as a type of computer-readable storage medium, may include an operating system, a network communication module, a user interface module, and a video compression application program.

In the electronic device 1000 shown in FIG. 5, the user interface 1003 is primarily configured to provide an input interface for the user and to receive input data from the user. The processor 1001 may be configured to invoke the video compression application program stored in the memory 1005 and specifically perform the following operations:

Model the original video sequence using an implicit neural representation (INR) model, so as to convert the original video sequence into network model parameters of the INR model; wherein the INR model is configured to extract fused encoding features containing temporal information and to perform spatial decoding and reconstruction. The fused encoding features are selected based on the original video sequence.

Perform modeling on an original video sequence using an INR model, so as to convert the original video sequence into network parameters of the INR model. The INR model is further configured to extract fusion encoding features containing temporal information and to perform spatial decoding and reconstruction. The fusion encoding features are selected based on the original video sequence.

Construct a loss function of the INR model based on the original video sequence and a reconstructed video, wherein the reconstructed video is obtained by reconstructing the original video sequence.

Perform iterative optimization of the network parameters using the loss function, and to determine, upon the optimized result meeting a predetermined condition, the final optimized network parameters as the video compression result corresponding to the original video sequence.

In one embodiment, when executing the operation of constructing the loss function of the implicit neural network based on the original video sequence and reconstructed video, the processor 1001 specifically performs the following steps:
Divide each frame in the original video sequence into multiple image blocks;
Use the encoder to add preset basic encoding features processed by sliding temporal windows with preset group-of-pictures level features to obtain fused encoding features which contain temporal information;
Extract the feature embedding representation corresponding to each image block from the fused encoding features, based on the coordinates of each image block;
Perform spatial decoding and reconstruction of the feature embedding representation corresponding to each image block to obtain the reconstructed video corresponding to the original video sequence.

Construct the loss function based on the original video sequence and the reconstructed video.

In one embodiment, when executing the operation of using the encoder to add preset basic encoding features processed by sliding temporal windows with preset group-of-pictures level features to obtain fused encoding features which contain temporal information, the processor 1001 specifically performs the following steps:
Process the original video sequence using the sliding temporal window to generate feature tensors for each frame;
Perform weighted fusion of the feature tensors of frames within the sliding temporal window to obtain fusion results of multiple local windows;
Integrate the fusion results of multiple local windows into temporally aligned fused features with respect to the time axis of the original video sequence;
Use preset basic encoding features, incorporating preset group-of-pictures level features into the temporally fused features to obtain fused encoding features containing temporal information.

In one embodiment, when executing the operation of using preset basic encoding features, incorporating preset group-of-pictures level features into the temporally fused features to obtain fused encoding features containing temporal information, the processor 1001 specifically performs the following steps:
Group the original video sequence into multiple sets of frames;
Assign a preset learnable feature tensor for each set of frames;
Element-wise add the learnable feature tensor to the temporally fused features.

In one embodiment, when executing the operation of extracting the feature embedding representation corresponding to each image block from the fused encoding features, based on the coordinates of each image block, the processor 1001 specifically performs the following steps:
Calculate mapping coordinates in the fused encoding features containing temporal information based on the image block coordinates of each image block;
Obtain the feature embedding representation corresponding to each image block from the fused encoding features according to the mapping coordinates;
The image block coordinates of each image block are determined based on the spatial coordinate index and the network encoding parameters of each image block in the original video sequence.

In one embodiment, when executing the operation of extracting the feature embedding representation corresponding to each image block from the fused encoding features, based on the coordinates of each image block, the processor 1001 specifically performs the following steps:
Calculate mapping coordinates in the fused encoding features containing temporal information based on the image block coordinates of each image block;
Obtain the feature embedding representation corresponding to each image block from the fused encoding features according to the mapping coordinates;
The image block coordinates of each image block are determined based on the spatial coordinate index and the network encoding parameters of each image block in the original video sequence.

In one embodiment, when executing the operation of performing spatial decoding and reconstruction of the feature embedding representation corresponding to each image block to obtain the reconstructed video corresponding to the original video sequence, the processor 1001 specifically performs the following steps:
Perform hybrid umsampling on the feature embedding representations corresponding to each image block using the hybrid upsampling layer, which applies different types of upsampling functions to obtain upsampled features;
Fuse the upsampled features through the feature fusion layers to generate hybrid upsampled features;
Determine the features of the current layer;
Use the cross-layer fusion mechanism to concatenate the hybrid upsampled features output by multiple feature fusion layers, then applying grouped convolution for dimensional mapping, and combining the result with the current layer's features to obtain the final features from the last upsampling module;
Extract features at each resolution through each upsampling module to obtain multi-resolution features;
Reconstruct the video using the features obtained from the last upsampling module to generate the reconstructed video corresponding to the original video sequence.

In one embodiment, when executing the operation of performing hybrid umsampling on the feature embedding representations corresponding to each image block using different types of upsampling functions, and fusing the upsampled features through the feature fusion layers to generate hybrid upsampled features, the processor 1001 specifically performs the following steps:
Perform bilinear interpolation on the feature embedding representations corresponding to each image block for upsampling, while simultaneously applying sub-pixel convolution upsampling on the same feature embedding representations through pixel shuffle;
Add the two types of upsampled features to obtain the hybrid upsampled features.

In one embodiment, when executing the operation of determining the features of the current layer, the processor 1001 specifically performs the following steps:
Extract features from the hybrid upsampled features using convolution layers with different kernel sizes to obtain convolution fused features;
Adjust the feature dimensions of the multi-resolution features through a linear transformation layer to obtain dimensional transformed features;
Slice the convolution fused features along the channel dimension and adding them to the dimensional transformed features to obtain the features of the current layer.

In one embodiment, when executing the operation of constructing the loss function based on the original video sequence and the reconstructed video, the processor 1001 specifically performs the following steps:
Downsample the original video sequence to obtain downsampled features;
Calculate a multi-scale loss based on the downsampled features and the multi-resolution features;
Compute the residual between the original video sequence and the reconstructed video, and extracting high-frequency residual information using a high-pass filter;
Construct a high-frequency loss term based on the high-frequency residual information;
Establish an expression combining the multi-scale loss and the high-frequency loss to serve as the loss function.

In the embodiment of the present application, on one hand, the implicit neural network is employed to extract fused encoding features containing temporal information and to perform spatial decoding and reconstruction. These fused encoding features are selected based on the original video sequence, thereby enabling full utilization of the spatial and temporal structural priors of the video to effectively remove redundant information and improve the compression efficiency. On the other hand, the implicit representation neural network model is capable of multi-scale feature fusion, which enhances the network's representation capability for video features, thereby optimizing the compression performance.

It will be understood by those skilled in the art that all or part of the processes in the foregoing method embodiments may be implemented by a computer program to instruct relevant hardware. The video compression program may be stored on a computer-readable storage medium and, when executed, may perform the steps of the aforementioned method embodiments. The computer-readable storage medium may include, but is not limited to, magnetic disks, optical discs, read-only memory (ROM), random access memory (RAM), and the like.

It should be noted that the above-described embodiments are merely preferred examples of the present application and are not intended to limit the scope of the claims. Any equivalent modifications or substitutions made within the scope of the claims of the present application shall fall within the protection scope of the present application.

1. A video compression method with multi-scale implicit neural representation, comprising:
modeling an original video sequence by an implicit neural network and convert the original video sequence to network parameters, wherein the implicit neural network is configured to extract fused encoding features containing temporal information and perform spatial decoding, and the fused encoding features are selected based on the original video sequence;
constructing a loss function of the implicit neural network based on the original video sequence and a reconstructed video, wherein the reconstructed video is obtained by reconstructing the original video sequence; and
iteratively optimizing the network parameters using the loss function until optimization results meet preset conditions, and using final optimized network model parameters as a video compression result corresponding to the original video sequence.

2. The video compression method according to claim 1, wherein the implicit neural network comprises an encoder and a decoder:
the step of constructing the loss function of the implicit neural network based on original video sequence and the reconstructed video comprises:
dividing each frame in the original video sequence into multiple image blocks;
using the encoder to add preset basic encoding features processed by a sliding temporal window with preset group-of-pictures level features to obtain the fused encoding features containing the temporal information;
extracting a feature embedding representation corresponding to each image block from the fused encoding features based on coordinates of each image block;
performing spatial decoding and reconstruction of the feature embedding representation corresponding to each image block to obtain the reconstructed video corresponding to the original video sequence; and
constructing the loss function based on the original video sequence and the reconstructed video.

3. The video compression method according to claim 2, wherein the step of using the encoder to add the preset basic encoding features processed by the sliding temporal window with the preset group-of-pictures level features to obtain the fused encoding features containing the temporal information comprises:
processing the original video sequence using the sliding temporal window to generate feature tensors for each frame;
performing weighted fusion of the feature tensors of frames within the sliding temporal window to obtain fusion results of a plurality of local windows;
integrating the fusion results of the plurality of local windows into temporally fused features aligned with respect to a time axis of the original video sequence; and
using the preset basic encoding features, incorporating the preset group-of-pictures level features into the temporally fused features to obtain the fused encoding features containing the temporal information.

4. The video compression method according to claim 3, wherein the step of using the preset basic encoding features, incorporating the preset group-of-pictures level features into the temporally fused features to obtain the fused encoding features containing the temporal information comprises:
grouping the original video sequence into multiple sets of frames;
assigning a preset learnable feature tensor for each set of frames; and
element-wisely adding the preset learnable feature tensor to the temporally fused features.

5. The video compression method according to claim 2, wherein the step of extracting the feature embedding representation corresponding to each image block from the fused encoding features based on the coordinates of each image block comprises:
calculating mapping coordinates in the fused encoding features containing the temporal information based on the coordinates of each image block; and
obtaining the feature embedding representation corresponding to each image block from the fused encoding features according to the mapping coordinates;
wherein the coordinates of each image block are determined based on a spatial coordinate index and network encoding parameters of each image block in the original video sequence.

6. The video compression method according to claim 2, wherein the decoder comprises a plurality of serially connected upsampling modules, wherein each upsampling module comprises a hybrid upsampling layer and a plurality of feature fusion layers, and each upsampling module is provided with a cross-layer fusion mechanism;
the step of performing spatial decoding and reconstruction of the feature embedding representation corresponding to each image block to obtain the reconstructed video corresponding to the original video sequence comprises:
performing hybrid umsampling on the feature embedding representations corresponding to each image block using the hybrid upsampling layer, which applies different types of upsampling functions to obtain upsampled features;
fusing the upsampled features through the plurality of feature fusion layers to generate hybrid upsampled features;
determining features of a current layer;
using the cross-layer fusion mechanism to concatenate the hybrid upsampled features output by the plurality of feature fusion layers, then applying grouped convolution for dimensional mapping, and combining a result with the features of the current layer to obtain final features from a last upsampling module;
extracting features at each resolution through each upsampling module to obtain multi-resolution features; and
reconstructing the video using the final features obtained from the last upsampling module to generate the reconstructed video corresponding to the original video sequence.

7. The video compression method according to claim 6, wherein performing hybrid umsampling on the feature embedding representations corresponding to each image block using different types of upsampling functions, and fusing the upsampled features through the feature fusion layers to generate the hybrid upsampled features comprise:
performing bilinear interpolation on the feature embedding representations corresponding to each image block for upsampling, while simultaneously applying sub-pixel convolution upsampling on the same feature embedding representations through pixel shuffle; and
adding two types of upsampled features to obtain the hybrid upsampled features.

8. The video compression method according to claim 6, wherein the step of determining the features of the current layer comprises:
extracting features from the hybrid upsampled features using convolution layers with different kernel sizes to obtain convolution fused features;
adjusting feature dimensions of the multi-resolution features through a linear transformation layer to obtain dimensional transformed features; and
slicing the convolution fused features along a channel dimension to be added to the dimensional transformed features to obtain the features of the current layer.

9. The video compression method according to claim 2, wherein the step of constructing the loss function based on the original video sequence and the reconstructed video comprises:
downsampling the original video sequence to obtain downsampled features;
calculating a multi-scale loss based on the downsampled features and multi-resolution features;
computing a residual between the original video sequence and the reconstructed video, and extracting high-frequency residual information using a high-pass filter;
constructing a high-frequency loss term based on the high-frequency residual information; and
establishing an expression combining the multi-scale loss and the high-frequency loss to serve as the loss function.

10. A multi-scale implicit neural representation video compression apparatus, comprising:
a modeling module, configured to model an original video sequence using an implicit representation neural network model, so as to convert the original video sequence into network model parameters of the implicit representation neural network model; wherein the implicit representation neural network model is configured to extract fused encoding features containing temporal information and to perform spatial decoding and reconstruction, and the fused encoding features are selected based on the original video sequence;
a construction module, configured to construct a loss function of the implicit representation neural network model based on the original video sequence and a reconstructed video, wherein the reconstructed video is obtained by reconstructing the original video sequence; and
an optimization module, configured to iteratively optimize the network model parameters using the loss function, and when an optimization result satisfies a preset condition, output final optimized network model parameters as a video compression result corresponding to the original video sequence.
